(19) United States
(12) Patent Application Publication
(10) Pub. No.: US 2011/0076575 A1
(43) Pub. Date: Mar. 31, 2011

(54) SYSTEM FOR THE AUTONOMOUS GENERATION OF HYDROGEN FOR AN ON-BOARD SYSTEM

(75) Inventors: Gilles L. Le Marois, La Tronche (FR); Philippe Baclet, Is-Sur-Tille (FR)

(73) Assignee: Commissariat A L'Energie Atomique Et Aux Energies Alternatives, Paris (FR)

(21) Appl. No.: 12/993,433

(22) PCT Filed: Apr. 29, 2009
(86) PCT No.: PCT/FR09/50789

§ 371 Date: Nov. 18, 2010

(30) Foreign Application Priority Data
May 20, 2008 (FR) 0853255

(51) Int. Cl. H01M 8/06; F02B 43/08; B01J 7/00; B01J 23/22; B01J 23/46; B01J 8/02

(52) U.S. Cl. 429/419; 123/3; 423/592.1; 502/325; 502/353; 428/220; 422/211; 422/198

(57) ABSTRACT

The present invention relates to a system for generating hydrogen for an on-board device comprising a system for regenerating the material consumed by the generation of hydrogen.

### CROSS REFERENCE TO RELATED APPLICATIONS

This application is a national stage application under 35 U.S.C. §371 of PCT Application No. PCT/FR2009/050789, filed Apr. 29, 2009, which claims priority to French Application No. FR 0853255, filed May 20, 2008, entitled “System For The Autonomous Generation Of Hydrogen For An On-Board System.

### FIELD OF THE INVENTION

The present invention relates to on-board systems, whose propulsion is ensured by hydrogen.

More specifically, it proposes an autonomous system for generating hydrogen in situ, using a regenerable material M.

### SUMMARY OF THE INVENTION

Hydrogen (H₂) is today considered to be the energy carrier of the future, particularly suited for propulsion of on-board systems (transport, construction equipment, etc.), to replace fossil fuels.

Accordingly, it should allow us: to address the shortage of fossil fuels; to not emit CO₂ when used for propulsion of on-board systems, and therefore to reduce the impact of human activity on climate change; to not emit pollutants when used for propulsion of on-board systems through a fuel cell, and therefore to reduce the impact to health, particularly in areas of high human population density; to greatly reduce noise pollution when used for propulsion of on-board systems through a fuel cell.

However, and in particular for on-board systems, in turning to this energy carrier a number of difficulties of various natures are met:

Accordingly, though hydrogen is very abundant, it is not a directly available resource: it is bound to other chemical elements, thereby forming diverse, generally very stable, molecules such as water, natural gas, etc. Therefore it must be produced from these molecules using diverse processes. The most common processes are reforming of fossil fuels and electrolysis of water.

Moreover, and within the scope of its use as a propulsion carrier for on-board systems, the strategies used or considered to date consist in producing hydrogen ex situ, transporting it, distributing it through dedicated infrastructures, storing it in on-board reservoirs and converting it into electrical energy via a fuel cell, or directly into mechanical energy by internal combustion. Specific constraints result from these various operations: since generation occurs essentially through reforming fossil fuels with CO₂ emission, it does not burden the problem of greenhouse gas emissions (GGE); transport and distribution require implementation of infrastructures that are a very large investment. There is also the as yet unresolved problem of regulation and safety linked to hydrogen; on-board storage, given the low volume density of hydrogen, is also a tight constraint. The solutions considered pose safety problems (high pressure) or complexity (hydrides).

Therefore, there is a need to develop simplified technical solutions allowing hydrogen to be used as the propulsion carrier for on-board systems.

Different on-board hydrogen generation systems have certainly already been proposed in the prior art.

Accordingly, US document 2005/0089735 describes a hydride storage reservoir, coupled to a fuel cell (FC) and a heat pump (HP). However, this reservoir has to be refilled with hydrogen once the hydrogen stored in the form of hydrides has been used up. This involves having available heavy hydrogen generation, distribution and storage infrastructures.

Using the chemical reaction with a salt from the borohydride family or derivatives thereof has also been proposed. Unfortunately, this reaction is not reversible or is only reversible under strong conditions and therefore, after consumption, the reagent has to be changed.

In both cases, the reservoir consumes its fuel, and it has to be resupplied regularly.

Water electrolysis, in particular using the “Proton Exchange Membrane” (PEM) electrolyser, has also been considered. In this case, there is function without any external material being supplied, since the water used by the electrolyser is compensated for by that produced by the fuel cell. However, the energy balance is unfavourable.

Electrolysers powered by solar panels or wind turbines also exist. However, the energy produced is intermittent and insufficient to propel an on-board system.

Internal reforming of fossil fuels or biofuels has also been proposed but this process produces impurities and pollutants.

According to another orientation and to have available a source of hydrogen generation that does not consume material apart from water, and does not produce pollutants, research has concentrated on thermochemical water-splitting cycles, including the overall reaction written as: H₂O [symbol] H₂+½O₂

This reaction has a large energy deficit, i.e. is endothermic, and requires, for direct dissociation, very high temperatures, above 2000° C.

Thermochemical water-splitting cycles, which involve several chemical reactions, aim to reduce this temperature to a level compatible with available heat sources.

Accordingly, the American Department of Energy (DOE) has published a reference base of more than 200 thermochemical cycles, from which most of the research has been undertaken. The types of heat sources considered for these cycles are nuclear, high temperature solar and geothermal. Other cycles functioning at temperatures as low as 500° C. have also been described, such as Cu-Cl, RbI, KBi cycles. However, these are complex cycles whose implementation is not very compatible with on-board application.

Among all the technical solutions described, the present invention follows the example of the system described in the US document 2005/089735, but overcomes the difficulties linked to the technology described in this document.

### DETAILED DESCRIPTION OF THE INVENTION

Accordingly, the present invention proposes on-board hydrogen generation, adapted to the load profile of the need and to coupling this generation with its conversion into electrical and/or mechanical energy, via a fuel cell or via a combustion engine.

According to certain embodiments, the whole is found in a system that does not require material or electricity to be provided externally. In this case, the invention relates to an on-board system functioning without any material or energy other than those drawn from the ambient environment via a heat pump.

More generally, and in principle, the invention relates to a hydrogen generation system from a material, comprising a compartment intended to regenerate the material used, using an energy supply.

Accordingly and according to a first aspect, the present invention covers a hydrogen generation system or generator from a material M serving as a reagent, said system comprising a regeneration system for material M consumed by hydrogen generation in an on-board device.

Advantageously, material M is an oxide forming a compound with oxygen that is at least binary.

Characteristically, the oxide is in the form of a porous material.

By definition, a porous material is characterised by open porosity allowing fluids to diffuse through the material and by a high specific total surface area or BET. According to the invention and to increase the kinetics of H₂ and O₂ generation, porous oxide materials with a high specific surface area, advantageously greater than or equal to 50 m²/g and that can even reach 1500 m²/g, are used.

Advantageously, the oxide used in the scope of the invention is a mesoporous material, defined as having porosity comprised between 2 and 50 nanometres according to the IUPAC standard.

The definitions, parameters and measurement methods for the porous materials are known to the skilled person are in particular described in the document by Rouquerol et al. [1].

In selecting thermochemical cycles producing hydrogen and oxygen from water, materials (M) having two forms of oxide with different valence are advantageously selected.

They have the advantage of being able to make this cycle in two stages, which simplifies implementation in on-board applications. The reactions involved are written thus:

M+H₂O [symbol] MO+H₂ (1)

MO [symbol] M+½O₂ (2)

In practice, the H₂ generation and regeneration system takes the form of a double heat exchanger well known to the skilled person. Accordingly, each of the two reactions takes place in one of the two exchangers E1 and E2, whose function can be switched.

Among these materials (M), vanadium oxides (V) are among the family of oxides that, like cerium (Ce), titanium (Ti) and also manganese (Mn), cobalt (Co), antimony (Sb), molybdenum (Mo) and tin (Sn) oxides, have remarkable reduction-oxidation properties, widely used to catalyse various reduction-oxidation reactions. These are advantageously used within the scope of the present invention.

Accordingly, the invention applies to these different oxide pairs, optionally in the presence of noble and doping catalysts.

Among them, the V₂O₃/V₂O₄ (V^{III}/V^{IV}) pair is advantageously selected because it has the following advantages: vanadium is one of the lightest elements, which gives a weight benefit in an on-board application; the two reactions involved are written thus:

V₂O₄ [symbol] V₂O₃+½O₂. (3)

V₂O₃+H₂O [symbol] V₂O₄+H₂ (4)

It transpires that reactions (3) and (4) are endothermic and each requires approximately equivalent energy input. Accordingly, this property is exploited by maintaining both compartments at the same temperature. Because of this, switching between the two circuits does not require a delay to return the temperatures in the two compartments to equilibrium and delivers H₂/O₂ power quasi-continuously.

Moreover, these two reactions require a certain temperature level, which can be supplied by the heat pump, the battery or the internal combustion engine. The battery and the engine can deliver a temperature that, generally, does not exceed 900° C. Practically and accounting for losses, it is estimated that the maximum available temperature in a vehicle is 600° C.

More generally, the invention applies to any system using reactions (1) and (2) whose reaction temperature does not exceed 600° C. What is more, the lower the temperature the more heat source is available to power the reactions, which deliver flexibility.

In practice, this applies to the pairs Ce^{III}/Ce^{IV}, Ti^{III}/Ti^{IV}, Mn^{III}/Mn^{IV}, Co^{II}/Co^{III}, Sb^{III}Sb^{IV}, V^{IV}V^{V}, Sn^{III}/Sn^{IV} and Mo^{III}/Mo^{IV}, which have similar redox and thermodynamic properties. As already stated, the preferred pair is V^{III}/V^{IV}.

Moreover, and to reduce said reaction temperature, the invention proposes different preferred embodiments: it transpires that reaction (2) only depends on the partial oxygen pressure. By maintaining this pressure at 0.01 mbar (i.e. an easily attainable primary vacuum), the reaction is made easier and the dissociation temperature of this reaction is reduced. In practice, the pressure that governs the regeneration system according to the invention is therefore advantageously less than or equal to 0.01 mbar.

J. Schoiswohl et al. have shown that the reduction of vanadium oxides is catalysed on the surface [2]. In the scope of the invention, by using mesoporous oxide materials for which the surface effects become non-negligible, the temperatures of reactions (1) and (2) are reduced.

The team of A. Kohl et al has shown that Rh acts as a catalyst for reducing vanadium oxides [3], which tends to reduce the reaction temperature (2), and the team of F. Sadi et al. has shown that Rh also favours reaction (1), applied to Ce^{III} hydrolysis. According to a preferred embodiment, nanoparticles of noble metals, such as Rh, but also Pt, Pd, Ir, Os, Au and Ag, are deposited on the surface of materials used within the scope of the invention.

H. Kaneko et al. and P. R. Shah et al. have shown that doping the surface of cerium or vanadium oxides with lower valence cations tends to make reaction (1) easier and reduce its temperature [5,6]. Accordingly and in a preferred way, the pairs of oxides cited above are doped using cations with lower valence, in practice valence 2 and 3 for V, Ce, Ti, Sb or valence 1 and 2 for Mn and Co.

By adding small quantities of hydrogen (H₂) released by reaction (for example by sweeping MO with a H₂/H₂O mixture), the oxygen potential is reduced and the regeneration reaction is favoured (2). Accordingly, and according to a preferred embodiment, the system according to the invention comprises means for removing the hydrogen produced from and re-introducing it into the regeneration system.

Moreover, by adding small quantities of oxygen (O₂), taken for example from ambient air (for example by sweeping M with a O₂/H₂O mixture), the oxygen potential is increased and the reaction is favoured (1). This reaction produces a H₂/H₂O mixture that can be easily separated, for example on a palladium membrane.

Finally, by using a small part of the electric energy supplied by the battery or by the electric generator to oxidise M or reduce MO, reactions (1) or (2) are made easier.

As already stated, the hydrogen generation system according to the invention is intended to be integrated into a more complex device, in particular an on-board device.

Advantageously, it comprises a reservoir that can store all or part of the hydrogen produced.

Also advantageously, it is intended to power with hydrogen, and also oxygen, a system for converting chemical energy into electrical or mechanical or thermal energy, itself intended to power a load.

The conversion system advantageously takes the form of a fuel cell (FC) or a H₂ combustion engine, advantageously coupled to an electrical generator, for example an alternator, a turbine or a thermoelectric device. In the case of an engine, it can further be powered by another fuel.

To better control H₂ and 0₂ supply in this conversion system, it is possible to act in two ways: by adjusting pressures above reagents M and MO using vacuum pumps; by placing buffer reservoirs downstream of the generator (generation system) equipped with, for example, regulation valves.

In another example, the hydrogen conversion system is completed by providing hydrogen coming from an extra hydrogen reservoir.

In another example, the conversion and regeneration systems can be connected by a heat-transfer circuit.

According to an advantageous embodiment, the device further comprises a device for supplying energy, advantageously a heat pump that can be powered electrically by the conversion system. This captures the calories in the ambient environment with a multiplication coefficient designated by COP, said heat energy being re-injected into the heat-transfer circuit.

Accordingly, and in a specific embodiment, the hydrogen generation system, the conversion system (fuel cell) and the heat pump are connected by a heat-transfer circuit in which a heat-transfer fluid, advantageously water, circulates, for example via a small peristaltic pump. The heat pump exchanges its calories by vaporising the fluid; the fluid is then re-heated by the fuel cell and in turn re-heats E1 and E2, with which it exchanges calories and condenses. The fluid then returns to the heat pump.

The invention applies to any heat-transfer fluid whose vaporisation temperature does not exceed the temperature supplied by the heat pump and that can exchange heat up to 700° C.

Note that it is possible to not use a heat pump. This is then a diminished version of the invention but that does offer an advantage: it does certainly require an external heat supply, but a reduced one: For a 50% fuel cell yield, the external supply SQ is reduced by half, so half as much energy is consumed. This supply can be obtained by coupling the system to a conventional combustion engine according to a hybrid configuration.

Alternatively, the energy supply device can supply chemical energy and is advantageously a hydrogen reservoir, or it can supply the electric energy, and is advantageously the conversion system.

Advantageously, the conversion system for the on-board device according to the invention powers an electric and/or mechanical load.

### EXAMPLE OF AN EMBODIMENT OF THE INVENTION

The way the invention can be made and the benefits that flow from it will become clearer from the embodiment example that follows, given as a non-binding indication, along with the appended figures.

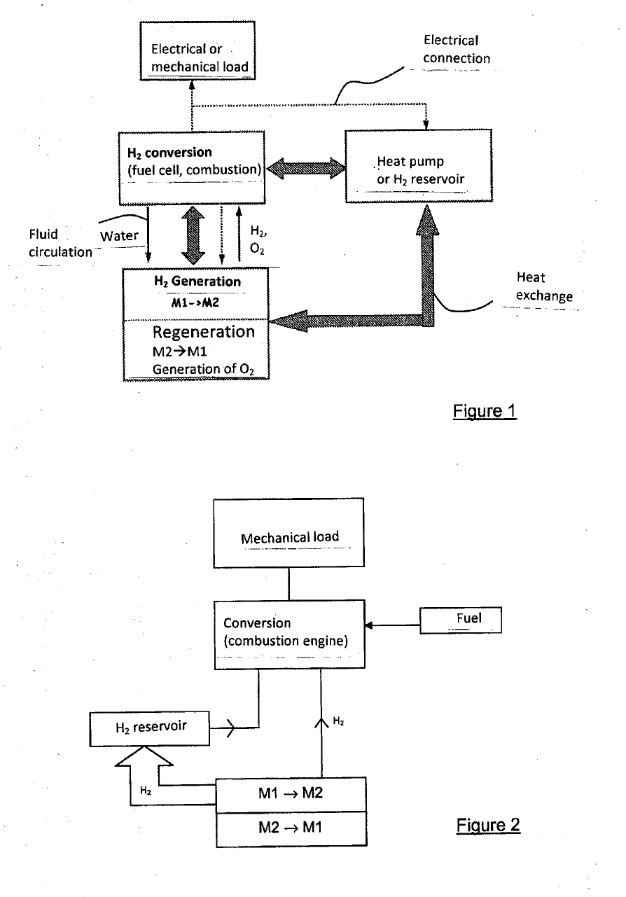

FIG. 1 shows a diagram of how the device according to the invention functions to allow autonomous hydrogen generation in an on-board system.

FIG. 2 shows a second embodiment of the same system.

### 1—SET-UP DESCRIPTION AND FUNCTION

The system for generating hydrogen that will be illustrated is based on the V₂O₃/V₂O₄ pair.

It is constituted of two heat exchangers, thermally isolated from the outside and heated through the heat-transfer circuit described below.

The first exchanger E1 initially contains vanadium oxide, V₂O₃. It is powered by water from the water reservoir (WR) via a small peristaltic pump. This exchanger is connected at the outlet to a circuit comprising a hydrogen separation membrane and a vacuum pump that extracts the hydrogen formed according to the reaction: V₂O₃+H₂O [symbol] V₂O₄+H₂

The second exchanger E2 initially contains V₂O₄. This exchanger is connected at the outlet to a circuit comprising a vacuum pump that maintains, above the oxide, a primary vacuum and extracts oxygen formed according to the reaction: V₂O₄ [symbol] V₂O₃+½O₂

In this exchanger, V₂O₃ is accordingly regenerated.

The system produces very pure hydrogen and oxygen, whose H/O ratio (globally equal to 2) and generation kinetics can be adjusted.

After the V₂O₃ is depleted in E1 and is regenerated in E2, the connections and the circuits linking them are switched, so E1 and E2 exchange functions. This means the system for converting H₂/O₂ can be powered continuously.

This generation system can power: either a fuel cell (FC) that then supplies electric energy, heat and water. This battery can function at high temperature (900° C.) or at low temperature (110° C.); or a combustion engine functioning at 900° C.

Water is recovered in the water reservoir (WR): the system does not consume material.

The electricity produced powers the electric engine and the various pumps.

The heat pump, powered electrically by the fuel cell, captures the calories in the ambient environment with a multiplication coefficient designated by COP, which it re-injects into the heat-transfer circuit.

The battery (fuel cell), the hydrogen generation system and the heat pump are connected by a heat-transfer circuit in which the heat-transfer fluid circulates through a small peristaltic pump. The heat pump exchanges its calories by vaporising the fluid; the fluid is then re-heated by the fuel cell and in turn re-heats E1 and E2 with which it exchanges calories and condenses. The fluid then returns to the heat pump.

There are two examples relating to energy supply: either the heat-transfer circuit is in two parts and separately heats exchangers E1 and E2, respectively at the temperature of vaporisation of the heat-transfer fluid through the heat pump (calories from the pump) and at 600° C. through the conversion system. These two reactions are then managed independently, which gives more options for the M/MO pair; or there is a single circuit that heats the exchangers at the same vaporisation temperature by using the latent heat of vaporisation of the fluid, for example water. Switching between the two exchangers is done without re-equilibrating the temperature, which allows continual generation.

The general functional principle of the system according to the invention is schematised in FIG. 1. In the embodiment, M1 represents V₂O₃, M2 represents V₂O₄ and the hydrogen is converted in a fuel cell.

FIG. 2 schematises another device according to the invention that is distinguished in that: the H₂ generation system is connected to a reservoir that allows a part of the H₂ produced to be stored; the conversion system, in this case a combustion engine, is powered both by the H₂ generation system and also by an external fuel source.

2—Set-up Test

Room temperature for the test is 20° C. The heat-transfer circuit is simple. The temperature in the heat-transfer fluid (water) at the entry of the H₂ and O₂ generation system stabilises at 100° C. The initial quantities added are 8.2 kg of V₂O₃ and 9.1 kg V₂O₄.

In a stable system, the production kinetics are established at 180 mmol/s for H₂ and 90 mmol/s for O₂. This corresponds to an overall energy supply for the fuel cell (FC), at its operating temperature of 100° C., being 45 kW.

The operation point for the fuel cell is such that its electrical yield is 50%. The fuel cell then supplies 22.5 kW of electrical power and 22.5 kW of heat power.

To compensate for the 45 kW needed to generate H₂ and O₂, 50 kW have been supplied in heat form to the H₂/O₂ generator: its yield is therefore 0.9.

These 50 kW are supplied on one hand by the battery (22.5 kW), and secondly by the heat pump (27.5 kW in heat form). At the test temperature, the COP yield for this pump is 4. The electrical power needed to power the pump is therefore 6.9 kW and the power drawn from in the environment is 20.6 kW.

The electrical generation balance by the fuel cell is established as follows: 6.9 kW for the heat pump, 1 kW for the auxiliary pumps and 14.6 kW for electric load.

The result for the test does show that the system according to the invention is capable of powering an electric load (14.6 kW delivered) thanks to an energy supply drawn from the heat pump in the environment (20.6 kW).

3/Influence of Porosity:

3-1/Synthesis of Vanadium Oxide and Doping with a Catalyst:

To synthesise vanadium oxide, V₂O₅, in the form of a mesoporous material with very high specific surface area (>100 m²/g BET), the synthetic process described in the Harreld et al. publication [7] was used.

The preparation is done via the Sol-Gel route and dried in supercritical route. The gel is then ground into micrometric powders. The specific total surface area (BET) obtained is then greater than 220 m²/g.

The Rh catalyst is deposited using MOCVD on the oxide powder. The amount of metal deposited is 0.5 wt %. The particles deposited are approximately 1-2 nm.

3-2/Test of V₂O₅ Heat Reduction, in the Presence of a Catalyst or not

Su and Schlögl [8] have reported that thermal decomposition of V₂O₅ into V0₂, then into V₂O₃, requires the oxide to be heated to 600° C. under a secondary vacuum, for 1 hour. However, using a secondary vacuum pump is incompatible with an on-board application.

For synthesised mesoporous oxides, before depositing Rh, the thermal decomposition tests were done using thermogravimetry under primary vacuum (more compatible with an on-board application) for this same duration of 1 h, at 350, 400, 450, 500, 550 and 600° C.

It was observed that the temperature of V₂O₅ decomposition into VO₂ drops to 450° C. For VO₂ into V₂O₃ it stays at 600° C., but under primary vacuum this time.

Therefore the mesoporous structure is seen to have an effect that eases reduction of these two oxide forms.

The same tests have been done after depositing the Rh catalyst. The presence of the catalyst also causes a reduction of 50 to 100° C. in the decomposition temperature of the two oxides, i.e. 500 and 400° C. respectively.

In the presence of argon+1% H₂, no changes were seen in reduction temperatures. However, the kinetics of oxide reduction are accelerated and reduction happens in less than 15 min.

3-3/V₂O₃ and VO₂ Hydrolysis Test in the Presence of Catalyst

Hydrolysis occurs in a fluid bed, by sweeping with water vapour, between 100 and 600° C. At each temperature level, hydrogen generation is measured at the output and continuously.

Kinetics of generation are expressed in micromoles of H₂ per second and per gram of vanadium.

a/VO₂+H₂O

H₂ generation is not measured between 100 and 600° C. By sweeping with H₂O+5 mol % O₂, at 100° C. a slight generation, less than 1, is detected.

b/V₂O₃+H₂O

By sweeping with pure H₂O, the following kinetics are measured: 10 at 100° C.; 12 at 200° C.; 11 at 300° C.

By sweeping with H₂O+5 mol % O₂, increased kinetics of generation are observed, especially at low temperature: 64 at 100° C.; 21 at 200° C.

### Conclusions

The V₂O₃/Vo₂ pair appears to be a good compromise for hydrogen generation and regeneration of the material in conditions that are compatible with an on-board system.

For the regeneration phase, the heat-based reduction of V₂O₅ into Vo₂ is done at lower temperature than that of V0₂ into V₂O₃. However, even in the second case, this temperature does not exceed 500° C.

For the H₂ generation (hydrolysis) phase, by combining mesoporosity, rhodium catalysis and the addition of a small amount of oxygen, significant, usable generation kinetics for H₂ generation are obtained at 100° C.

More qualitatively, a catalytic technique using electrochemical promotion applied to these oxides coated with Rh showed an increase in catalytic activity that leads to a drop in temperature for both reactions.

### REFERENCES

[1]: J. Rouquerol et al., Pure & Appl. Chem., 66(8) (1994) 1739-1758

[2]: J. Schoiswohl et al., Phys. Rev. B71, 165437 (2005)

[3]: A. Kohl et al., Phys. Stat. Sol. (a) 173, 85 (1999)

[4]: F. Sadi et al., Journal of Catalysis 213 (2003) 226-234

[5]: H. Kaneko et al., Energy 32 (2007) 656-663

[6]: P. R. Shah et al., J. Phys. Chem. C (2008), 112, 2613-2617

[7]: J. H. Harreld et al., Materials Research Bulletin, 33(4) (1998) 561-567

[8]: D. S. Su and R. Schlögl, Catalysis Letters, 83 (2002) 3-4, 115-119

1. A hydrogen generation system for an on-board device comprising a system for regenerating the material consumed by hydrogen generation, said material being a porous oxide, advantageously a mesoporous oxide.

2. The hydrogen generation system according to claim 1, wherein the material has two forms of oxides with different valences.

3. The hydrogen generation system according to claim 1, wherein the material is selected from among the group constituted by vanadium (V), cerium (Ce), titanium (Ti), manganese (Mn), cobalt (Co), antimony (Sb), molybdenum (Mo) and tin (Sn) oxides.

4. The hydrogen generation system according to claim 3, wherein the material is the V₂O₃/V₂O₄ pair.

5. The hydrogen generation system according to claim 1, wherein the surface of the oxide material is covered with nanoparticles of a noble metal, such as rhodium (Rh).

6. The hydrogen generation system according to claim 1, wherein the oxide pair is doped using cations with lower valence.

7. The hydrogen generation system according to claim 1, wherein the oxide material has a specific surface area greater than or equal to 50 m²/g.

8. The hydrogen generation system according to claim 1, wherein the system comprises means of removing and re-introducing the hydrogen produced in the regeneration system.

9. The hydrogen generation system according to claim 1, wherein the regeneration system is a heat exchanger.

10. The hydrogen generation system according to claim 1, wherein it comprises means of maintaining the pressure in the regeneration system at a value less than or equal to 0.01 mbar.

11. An on-board device comprising a hydrogen generation system, the hydrogen generation system having a system for regenerating material consumed by hydrogen generation, the material being a porous oxide, advantageously a mesoporous oxide.

12. The on-board device according to claim 11, wherein it comprises a reservoir that can store all or part of the hydrogen produced.

13. The on-board device according to claim 11, wherein it further comprises a hydrogen conversion system, advantageously a fuel cell or a combustion engine advantageously coupled to an electric generator, powered by the hydrogen generation system.

14. The on-board device according to claim 13, wherein the combustion engine is powered by a second fuel.

15. The on-board device according to claim 11, wherein the hydrogen generation system and the conversion system are connected by a heat-transfer circuit in which a heat-transfer fluid circulates.

16. The on-board device according to claim 11, wherein the device further comprises a device that supplies the energy for regeneration.

17. The on-board device according to claim 16, wherein the device for supplying energy can supply heat energy, and is advantageously a heat pump.

18. The on-board device according to claim 16, wherein the device for supplying energy can supply chemical energy, and is advantageously a hydrogen reservoir.

19. The on-board device according to claim 16, wherein the device for supplying energy can supply electrical energy, and is advantageously a conversion system.

20. The on-board device according to claim 13, wherein the conversion system powers an electrical and/or mechanical load.

21. The on-board device according to claim 11, wherein the material has two forms of oxides with different valences.

22. The on-board device according to claim 11, wherein the material is selected from among the group constituted by vanadium (V), cerium (Ce), titanium (Ti), manganese (Mn), cobalt (Co), antimony (Sb), molybdenum (Mo) and tin (Sn) oxides.

23. The on-board device according to claim 22, wherein the material is the V₂O₃/V₂O₄ pair.

24. The on-board device according to claim 11, wherein the surface of the oxide material is covered with nanoparticles of a noble metal, such as rhodium (Rh).

25. The on-board device according to claim 11, wherein the oxide pair is doped using cations with lower valence.

26. The on-board device according to claim 11, wherein the oxide material has a specific surface area greater than or equal to 50 m²/g.
